(19) United States
(12) Patent Application Publication
(10) Pub. No.: US 2004/0181900 A1
(43) Pub. Date: Sep. 23, 2004

(54) Floor covering positioner

(76) Inventors: Patricia J. Horst, Rockford, IL (US); Bruce E. Horst, Rockford, IL (US)

Correspondence Address: LEYDIG VOIT & MAYER, LTD, 6815 WEAVER ROAD, ROCKFORD, IL, 61114-8018, US

(21) Appl. No.: 10/803,308

(22) Filed: Mar. 18, 2004

Related U.S. Application Data
(63) Continuation-in-part of application No. 10/393,136, filed on Mar. 20, 2003.

(51) Int. Cl. B32B 3/00

(52) U.S. Cl. 16/4

(57) ABSTRACT

An apparatus, for securing a floor covering on an underlying substrate, includes a button-like central base member that is adapted for placement between the floor covering and the carpet. The central base member includes an upper surface for engaging the floor covering and a lower surface for attachment to the substrate. The upper surface of the base member includes an adhesive, or a plurality of upwardly extending spikes, or a plurality of hooks engaging with a mating plurality of downwardly extending hooks of an anchor tab, for engaging the lower surface of the floor covering. The lower surface of the base member includes an adhesive, or one or more downwardly extending spikes for engaging or attaching the apparatus to the underlying substrate. One or more of the downwardly extending spikes may include barbs or a screw thread for engaging a lower side of a backing of a substrate having a pile layer extending upward from the backing.

### CROSS-REFERENCE TO RELATED PATENT APPLICATIONS

This patent application is a continuation in part of copending U.S. patent application Ser. No. 10/393,136, filed Mar. 20, 2003.

### FIELD OF THE INVENTION

This invention pertains to securing mechanisms for floor coverings such as rugs, and more particularly to apparatus for positioning and securing movable floor coverings, such as rugs, upon an underlying substrate, such as a floor covered with wood, tile, or carpet.

### BACKGROUND OF THE INVENTION

There are various types of floor coverings used in residential and commercial applications. As used herein, the term “floor covering” or “movable floor covering” is meant to be very broad to include carpet, rugs, mats, floor mats, runners, and other coverings made of fabric, animal skin, nap material, pile material and/or other suitable floor covering material. One long existing problem is that when a movable floor covering such as a rug is placed over a underlying substrate, the rug tends to wander or naturally slide out of place over time as it is walked upon. As used herein, the term “underlying substrate” is intended to encompass all commonly used types of floor surfaces, including, but not limited to, carpet, wood, tile, brick, concrete, metal and vinyl, etc.

### BRIEF SUMMARY OF THE INVENTION

The present invention provides an apparatus for securing a floor covering on an underlying substrate. The apparatus includes a button-like central base member that is adapted to be placed between the floor covering and the underlying substrate. The central base member includes an upper surface that is adapted for engaging the floor covering, and a lower surface that is adapted for attachment to the substrate.

In one form of the invention, for securing a floor covering on a carpet, a plurality of spikes extend vertically upward from the central base member and are adapted to engage the floor covering. A plurality of spikes also extend vertically downward from the central base member and are adapted to engage the carpet. One or more of the upwardly and/or downwardly extending spikes may also include one or more barbs for engaging the floor covering or the underlying substrate.

The device may be operated by placement between a rug and an underlying substrate. The rug can then be stepped on which can lock the rug in place over the underlying substrate.

A system is also disclosed herein for using one or more apparatuses, according to the invention, as rug positioners, to secure and hold stationary a rug or other floor covering on an underlying substrate.

In another form of the invention, for use on an underlying substrate such as a carpet having a layer of pile extending upward from a backing, the lower surface of the central base member includes one or more downwardly extending spikes that are adapted to pass through the layer of pile and engage the backing of the underlying substrate. The apparatus may include one or more downwardly extending spikes that penetrate completely through the backing, and have a barb on the distal end of one or more of the spikes for engaging a lower surface of the backing. The apparatus may alternatively have a single downwardly extending spike, having a thread on an outer surface thereof for threadably engaging the lower surface of the backing of the underlying substrate.

The upper surface of the central base member, of an embodiment of the invention having one or more downwardly extending spikes that are adapted to pass through the layer of pile and engage the backing of the underlying substrate, may be configured in a variety of ways to include a layer of adhesive, a plurality of upward extending spikes, or a plurality of hooks mating with a corresponding plurality of hooks extending downward from an anchor tab that is adhesively bonded to the lower surface of the floor covering that is to be secured to the substrate.

In yet another form of the invention, an apparatus for securing the floor covering to a smooth-surfaced substrate, includes an adhesive attached to the lower surface of the central base member. The upper surface of the central base member, of an embodiment of the invention having an adhesive attached to the lower surface of the central base member, may be configured in a variety of ways to include a layer of adhesive, a plurality of upward extending spikes, or a plurality of hooks mating with a corresponding plurality of hooks extending downward from a an anchor tab that is adhesively bonded to the lower surface of the floor covering that is to be secured to the substrate.

In forms of the invention having an adhesive on any of the upper or lower surfaces of the central base member, or on an anchor tab, the apparatus may further include a removable protective membrane that is peeled off to expose the adhesive for bonding to a respective surface of the underlying substrate or the floor covering.

Other aspects, objectives and advantages of the invention will become more apparent from the following detailed description when taken in conjunction with the accompanying drawings.

### BRIEF DESCRIPTION OF THE DRAWINGS

FIG. 1 is an isometric illustration of a first exemplary embodiment of an apparatus, according to the invention, for securing a floor covering on an underlying substrate.

FIG. 2 is an isometric exploded illustration of a floor covering positioning system, according to the invention, using the apparatus shown in FIG. 1, for securing a floor covering on an underlying substrate.

FIG. 3 is a cross sectional illustration of the apparatus of FIG. 1, showing the apparatus in use, securing a floor covering on an underlying substrate.

FIG. 4 is a cross-sectional illustration of a second embodiment of an apparatus for securing a floor covering on an underlying substrate, according to the invention, showing the apparatus in use, securing a floor covering on an underlying substrate.

FIG. 5 is a cross-sectional illustration of a third exemplary embodiment of an apparatus, according to the invention, showing the apparatus in use, securing a floor covering on an underlying substrate.

FIG. 6 is a cross-sectional illustration of a fourth exemplary embodiment of an apparatus, according to the invention, showing the apparatus in use, securing a floor covering on an underlying substrate.

FIG. 7 is a top view of the apparatus shown in FIG. 6.

FIG. 8 is a cross-sectional illustration of a fifth exemplary embodiment, according to the invention, of an apparatus for securing a floor covering on an underlying substrate having a smooth surface.

FIGS. 9-12 are cross-sectional illustrations of alternate exemplary embodiments of the apparatuses, according to the invention, illustrated in FIGS. 5-8.

Throughout the drawings and the following description of exemplary embodiments of the invention, like features are identified with the same reference numbers.

### DETAILED DESCRIPTION OF THE INVENTION

The following disclosed embodiments further illustrate the invention, but should not be construed as in any way limiting its scope.

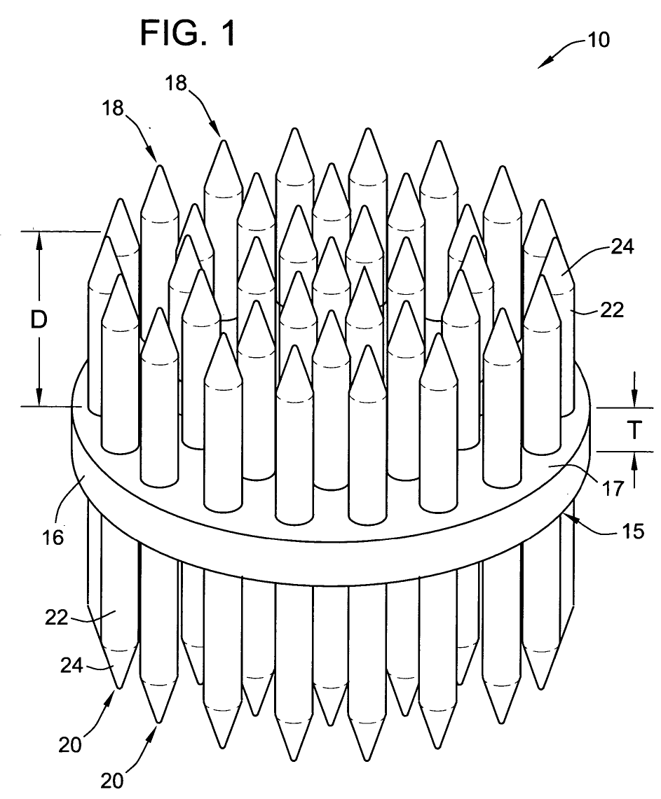

In all of the exemplary embodiments of the invention described below, with reference to FIGS. 1-11, an apparatus for securing a floor covering 12 to an underlying substrate 14 includes a button-like central base member 16 that is adapted to be placed between the floor covering 12 and the underlying substrate 14. The central base member 16 includes an upper surface 17 thereof adapted for engaging the floor covering, and a lower surface 15 thereof adapted for attachment to the substrate 14.

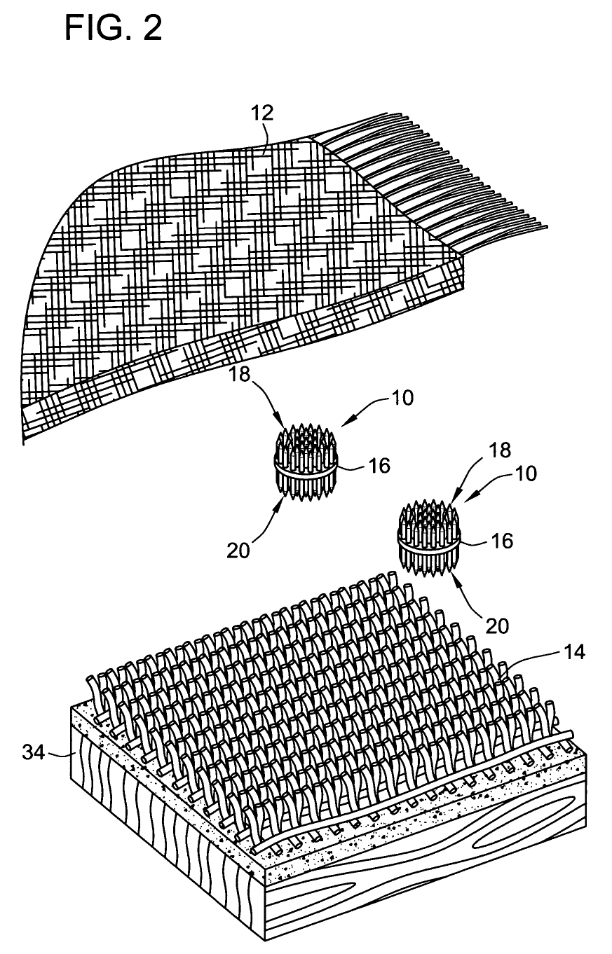

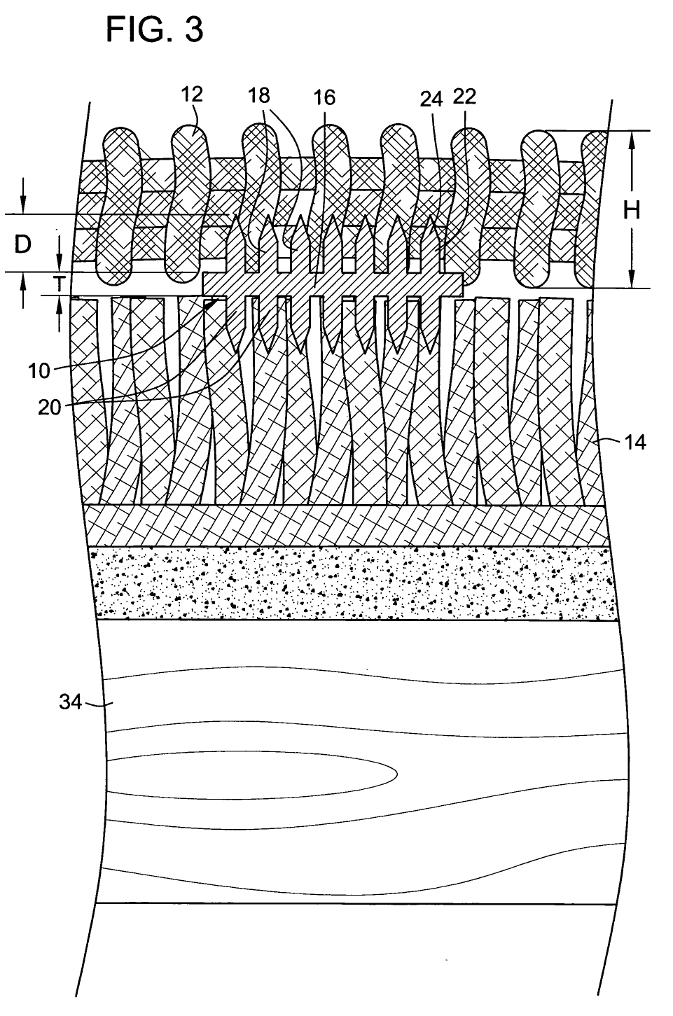

In a first exemplary embodiment of the invention, as shown in FIG. 1, a rug positioning apparatus 10 is illustrated, for securing a rug 12 or other suitable floor covering on an underlying substrate in the form of a surface of a carpet 14, in the manner showing FIGS. 2 and 3. The rug positioning apparatus 10 includes a central base member 16 that is adapted to be placed between the rug 12 and the carpet surface 14. Preferably the central base member 16 is disc shaped, planar and relatively thin so as to prevent or minimize the formation of bumps in the rug when installed. The central base member 16 may have a vertical cross-sectional thickness T in the range of between about ⅛-¼ inches.

A plurality of spikes 18 extend vertically upward from an upper surface 17 of the central base member 16. These spikes 18 are configured for engaging and preferably penetrating the fabric/pile material of the rug 12 when the rug 12 is stepped upon. A plurality of spikes 20 also extend vertically downward from a lower surface 15 of the central base member 14. These spikes 20 are configured for engaging and preferably penetrating the fabric/pile material of the carpet surface 14. The spikes 18, 20 may extend perpendicularly as shown to more easily facilitate penetration of the spikes into the carpet and floor covering material or may be angled if desired.

The spikes 18, 20 may be equally shaped and of the same or similar configuration as is shown. Alternatively the bottom spikes 20 may be longer in length. As shown, each spike 18, 20 includes a shank portion 22 projecting from the central base member 16 and a pointed tip 24 that can engage/grip and/or penetrate the material of the carpet 14 and rug 12.

Preferably, the spikes 18, 20 extend a vertical distance long enough to penetrate into the rug 12 but not long enough to penetrate all the way through the rug 12. This way, when people are walking barefoot on the rug 12, they do not injure themselves with the spikes. The pointed tips 24 of the spikes 18, 20 may be slightly rounded in configuration and not sharp for safety reasons.

For most commercially available floor coverings, the vertical distance D and length of the spikes 18, 20 (if perpendicularly oriented) is between about ⅛-¼ inches. However actual length will depend upon the vertical height of the rug as the spikes 18, 20 are intended to extend a vertical distance D that is less than about 75% of the vertical height H of the rug 12, while in a free and uncompressed state.

To facilitate fixation of the rug positioning apparatus 10 to carpet or floor covering material, the rug positioning apparatus 10 may be comprised of any suitably rigid material such as metal, a rigid plastic, or a combination of suitably rigid materials. As shown in FIG. 1, the spikes 18, 20 and the central base member 16 may be unitary and integrally formed together such as by molding, providing for inexpensive manufacture.

A system of using the rug positioning apparatus 10 is illustrated in FIGS. 2 and 3. As shown therein, one or more rug positioning apparatuses 10 are inserted and placed between the rug 12 and the carpet surface 14. Depending upon rug size and usage, a rug may need 1, 2, 4, 6 or more apparatuses 10, placed in selectively spaced pattern by the user. Ordinarily, the underlying substrate 14 will be a floor 34, or will already be held or fixed in place on the floor 34. One set of spikes 20 engage and preferably penetrate the carpet surface 14 when pushed into the carpet or when the overlying rug 12 is stepped upon over the apparatus 10 which in turn fixes the position of the rug positioning apparatus 10. The other set of spikes 18 are pushed into the material of the rug 12 (e.g. the rug is placed on the rug positioning apparatus 10 and stepped upon to lock the rug in place). Since the rug positioning apparatus 10 is fixed, the spikes 18 hold the lateral position of the rug 12 fixed, preventing the rug from wandering or migrating when walked across and used.

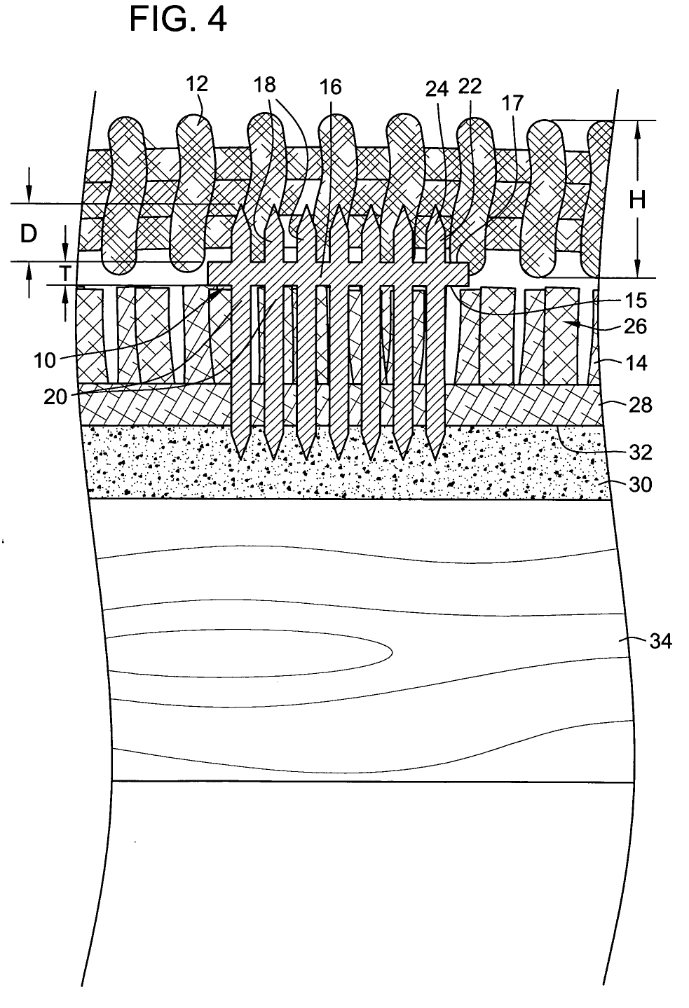

FIGS. 4 through 7 show exemplary embodiments of an apparatus 10, according to the invention, for anchoring the floor covering 12 to the backing of an underlying substrate 14 that includes a layer of pile 26 extending upward from a backing 28. The lower surfaces 15 of the central base members 16 of the embodiments shown in FIGS. 4-7 include one or more downwardly extending spikes 20 that are adapted to pass through the layer of pile 26 and engage the backing 28 of the underlying substrate 14. At least one of the one or more downwardly extending spikes 20 is adapted to penetrate completely through the backing 28 of the underlying substrate 14, and into a pad 30 installed between a lower surface 32 of the backing 28 of the substrate 14 and a floor 34. Having at least one downwardly extending spike 20 engage the backing 28 in this manner provides significantly enhanced performance of an apparatus 10, according to the invention, in securing the floor covering 12 on the substrate 14.

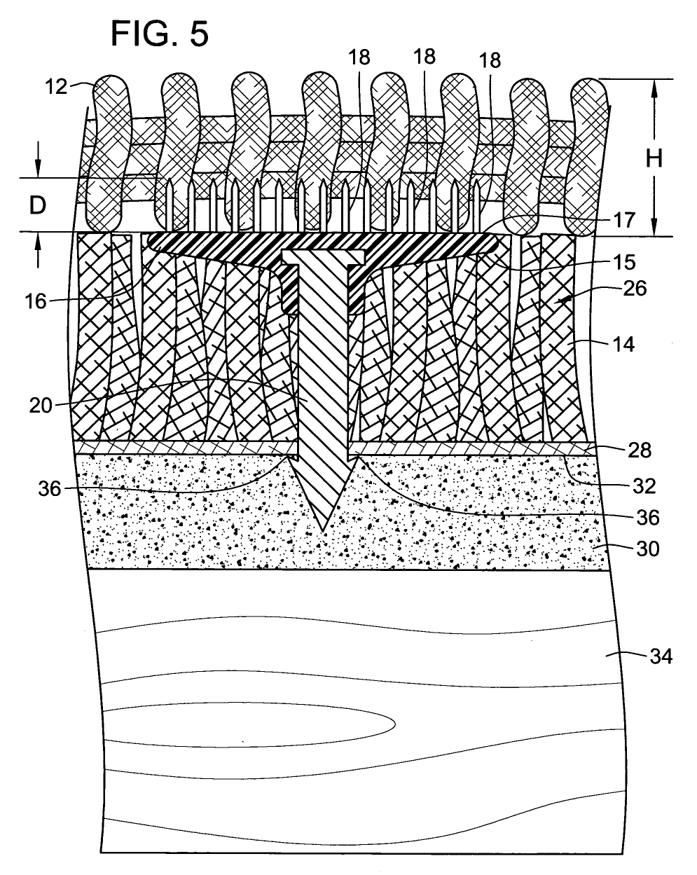

FIG. 5 shows an embodiment of an apparatus 10, according to the invention, having a single downwardly extending spike 20 that includes barbs 36 at a distal end thereof, for engaging the lower surface 32 of the backing 28 of the underlying substrate 14, so that once the barbed end of the spike 20 is pushed through the backing 28, the barbs 36 will bite into the lower surface 32 of the backing 28, and securely attach the apparatus 10 to the substrate 14. In alternate embodiments of the invention, it may be desirable to have several downwardly extending spikes 20 include barbs 36 for attaching the apparatus 10 to the backing in the manner shown in FIG. 5.

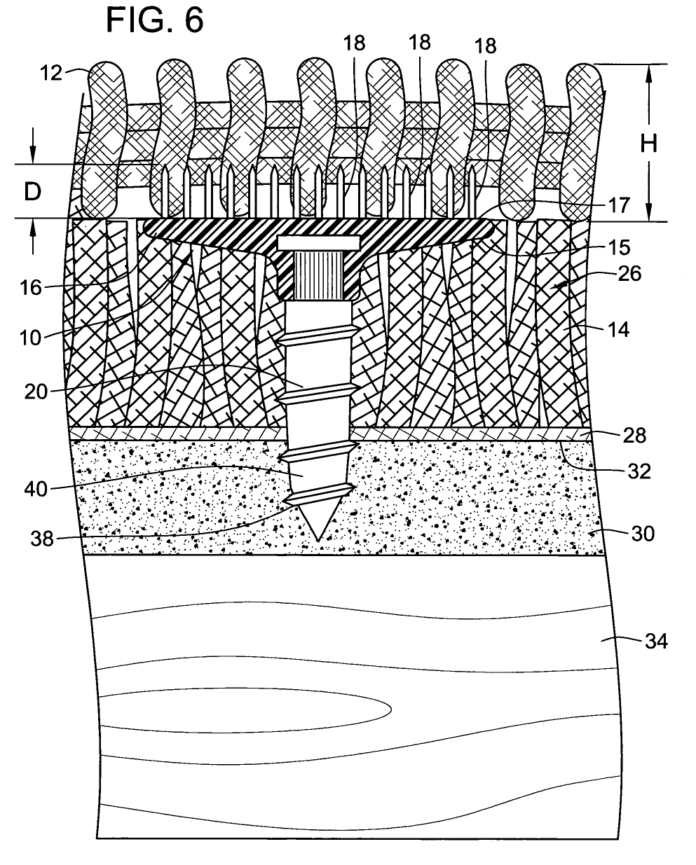

FIG. 6 shows an embodiment of an apparatus 10, according to the invention, having a single downwardly extending spike 20 that includes a screw thread 38 on an outer surface 40 thereof, for engaging the lower surface 32 of the backing 28 of the underlying substrate 14, so that once the threaded spike 20 is screwed through the backing 28, the thread 38 will bite into the lower surface 32 of the backing 28, and securely attach the apparatus 10 to the substrate 14.

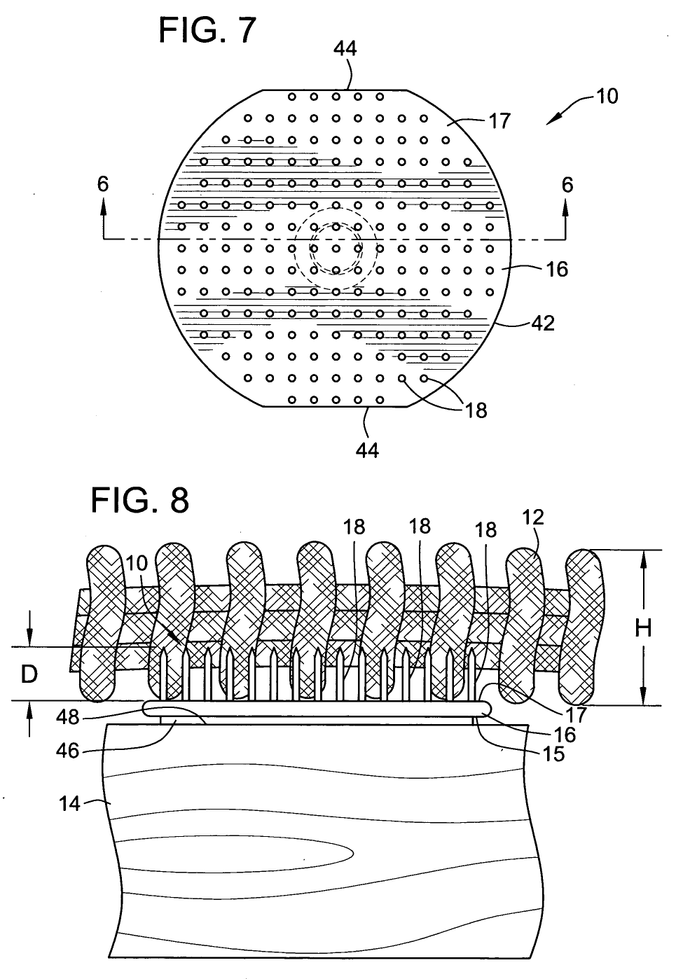

To make it easier to screw the apparatus 10 of FIG. 6 into the backing 28 of the substrate 14, it may be desirable to configure an outer periphery 42 (see FIG. 7) of the central base member 16 to include torque receiving features, such as flats 44, that facilitate grasping and turning the apparatus 10 as it is being screwed into the backing 28. Alternatively, it may be desirable to have the periphery 42 of the central base member 16 be knurling or otherwise roughened, or be irregularly shaped to facilitate grasping the apparatus 10 while screwing the threaded spike 20 into the backing 28. It may further be desirable to provide special features such as the flats, holes, slots, or drive sockets, that can be engaged by a wrench or other installation tool, or which function as an installation tool for effectively and efficiently receiving and transferring the torque applied by a person screwing the apparatus 10 into the backing 28.

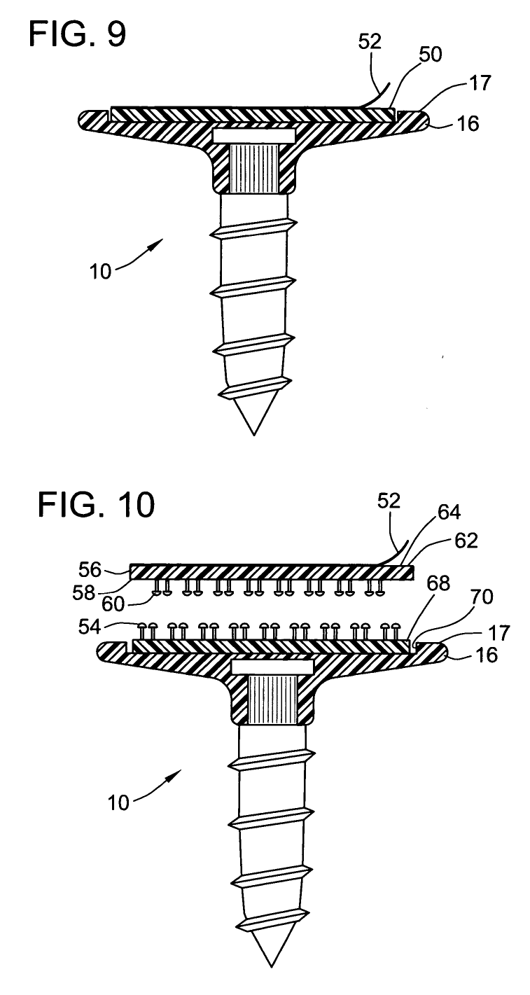

FIG. 8 shows an embodiment of an apparatus 10, according to the invention, wherein the lower surface 15 of the central base member 16 includes an adhesive 46 for attaching the apparatus 10 to an underlying substrate 14 having a relatively smooth upper surface 48.

As shown in FIGS. 4-8, the upper surfaces 17 of the central base members 16 of the embodiments shown in FIGS. 4-8 may include a plurality of upwardly extending spikes 18, of the same type described above in relation to the embodiments of FIGS. 1-3, for engaging and securing the floor covering 12. The upper surfaces 17 of the central base member 16 may also be adapted in other ways, however, for securing the floor covering 12 to an apparatus 10, according to the invention.

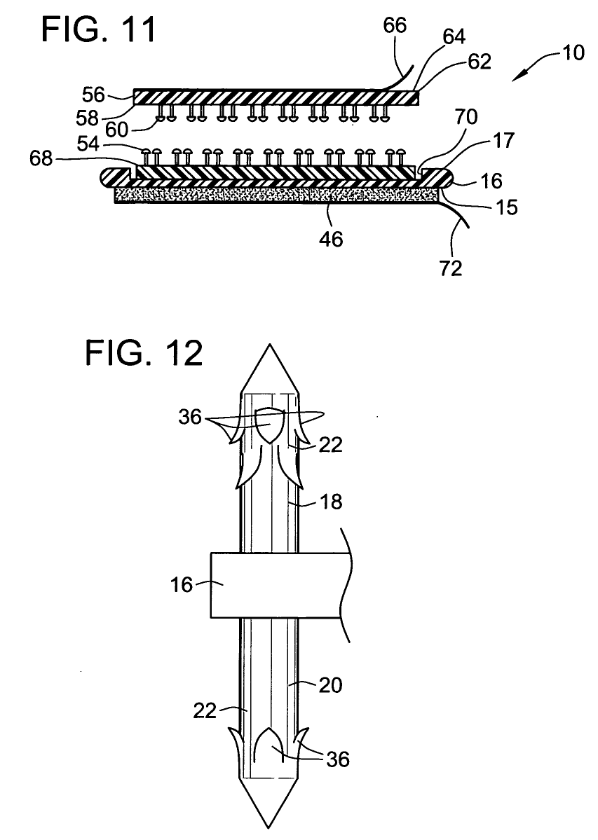

As illustrated in FIG. 9, for example, the upper surface 17 of the central base member 16 of any embodiment of an apparatus 10, according to the invention, may include an adhesive 50, instead of the upwardly extending spikes 18, for securing the floor covering 12 to the apparatus 10. It may also be desirable to provide a removable protective membrane 52, that protects the adhesive 50 during attachment of the apparatus 10 to the underlying substrate 14, and that can be peeled off to expose the adhesive 50 for securing the floor covering 12 to the apparatus 10.

FIG. 10 shows a preferred adaptation of the upper surface 17 of a central base member of the invention, in which the a plurality of hooks 54 extend upward from the upper surface 17 of the central base member 16, and the apparatus 10 includes an anchor tab 56 having a lower surface 58 thereof including a plurality of mating hooks 60 for engaging the hooks 54 extending from the upper surface 17 of the central base member 16. The upper surface 62 of the anchor tab 56 includes an adhesive 64 for attachment of the anchor tab 56 to the lower surface of the floor covering 12. It is further desirable to have the apparatus 10 include a removable protective membrane 66, that protects the adhesive 64 on the upper surface 62 of the anchor tab 56 during attachment of the apparatus 10 to the underlying substrate 14, and that can be peeled off to expose the adhesive 50 for securing the floor covering 12 to the anchor tab 56.

It is contemplated that, when installing an apparatus 10 having an upper surface 17 including hooks 54 adapted to mate with hooks 58 on an anchor tab 56, that the anchor tab 56, with its protective membrane 66 still in place, remain attached to the central base member 16, using the hooks 54, 58, during attachment of the apparatus 10 to the underlying substrate 14. After the central base member 16 is attached to the substrate 14, the protective membrane 66 is removed, the floor covering 12 is laid in place over the upper surface 62 of the anchor tab 56, and the floor covering 12 is bonded to the adhesive 64 on the anchor tab 56 by stepping down on the floor covering 12 above the apparatus 10.

In the embodiment shown in FIG. 10, the upwardly extending hooks 54 are part of a base pad 68, which is adhesively bonded into a recess 70 defined by the upper surface 17 of the central base member 16. The base pad 68 and the anchor pad 56 can be formed from a material sold under the trade name “Dual Lock,” by 3M Company, of Saint Paul, Minn., or from any other material that functions in a similar manner. The upwardly extending hooks 54 may alternatively be formed integrally with the central base member 16.

FIG. 11 shows yet another embodiment of the invention in which an apparatus 10, having a lower surface 15 of the central base member 16 configured to include an adhesive 46 for attaching the apparatus to a smooth surface 48, includes a base pad 68 in a recess 70, and the apparatus 10 includes an anchor tab 56 for joining the apparatus 10 to the floor covering 12. The apparatus 10 shown in FIG. 11 also includes removable protective membranes 66, 72 covering the adhesive 64, 46 on both the upper surface 62 of the anchor tab 56 and the lower surface 15 of the central base member 16.

Although the present invention has been described herein, with regard to a number of exemplary embodiments, those having skill ion the art will readily recognize that many other embodiments of the invention are also possible, and that the elements described herein can be used separately or in other combinations, in accordance with the invention.

For example, although the upwardly and downwardly extending spikes 18, 20 in the embodiments of FIGS. 1, 2, and 4 are illustrated as being integrally formed with the central base member16, and from the same material as the central base member, in alternate embodiments of the invention it may be desirable to form the spikes 18, 20 of a metal material and integrally join them to a central base member 16 made from a plastic material. In similar fashion, although the single downwardly extending spike 20 is illustrated in FIGS. 5, 6, and 10 as a metal part that is bonded, or molded into a central base member 16 made of a plastic material, in alternate embodiments of the invention, the single downwardly extending spike 20 can be formed integrally with a central base member 16 that is metal or a rigid plastic material. The upwardly extending spikes 18 of the embodiments shown in FIGS. 5, 6 and 8 or similar alternate embodiments, can also be formed integrally with the central base member 16, from the same member, of alternatively formed of different materials that are integrally joined together to form an apparatus 10 according to the invention. As illustrated in FIG. 12, in all embodiments of the invention using upwardly or downwardly extending spikes 18, 20, one or more of the upwardly and/or downwardly extending spikes 18, 20 may also include one or more barbs 36 for engaging the floor covering 12 and/or the underlying substrate 14.

It is also contemplated that the invention may be utilized to advantage in securing floor coverings to substrates other than floors.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An apparatus for securing a floor covering to an underlying substrate, the apparatus comprising:
a button-like central base member adapted to be placed between the floor covering and the underlying substrate;
the central base member having an upper surface thereof adapted for engaging the floor covering, and a lower surface thereof adapted for attachment to the substrate.

2. The apparatus of claim 1, wherein at least one of the upper and lower surfaces includes one or more spikes extending therefrom, with at least one of the one or more spikes having one or more barbs extending therefrom for engaging at least one of the floor covering or the underlying substrate.

3. The apparatus of claim 1, wherein the underlying substrate includes a layer of pile extending upward from a backing, and the lower surface of the central base member includes one or more downwardly extending spikes that are adapted to pass through the layer of pile and engage the backing of the underlying substrate.

4. The apparatus of claim 3, wherein the upper surface of the central base member includes a plurality of upwardly extending spikes that are adapted to engage the floor covering.

5. The apparatus of claim 3, wherein the upper surface of the central base member includes an adhesive for bonding a lower surface of the floor covering to the upper surface of the central base member.

6. The apparatus of claim 5, wherein the adhesive is covered by a removable protective membrane, that is that is peeled off to expose the adhesive for attachment to the lower surface of the floor covering.

7. The apparatus of claim 6, further comprising:
a plurality of hooks extending upward from the upper surface of the central base member; and
an anchor tab having a lower surface thereof including a plurality of mating hooks for engaging the hooks extending from the upper surface of the central base member, and an upper surface thereof including an adhesive for attachment of the anchor tab to the lower surface of the floor covering.

8. The apparatus of claim 7, further comprising a removable protective membrane covering the adhesive on the anchor tab, that is that is peeled off to expose the adhesive for attachment to the lower surface of the floor covering.

9. The apparatus of claim 3, wherein at least one of the one or more downwardly extending spikes is adapted for penetrating completely through the backing of the underlying substrate.

10. The apparatus of claim 9, wherein the upper surface of the central base member includes a plurality of upwardly extending spikes that are adapted to engage the floor covering.

11. The apparatus of claim 9, wherein the backing of the underlying substrate defines a lower surface thereof, and at least one of the one or more downwardly extending spikes includes a barb at a distal end thereof for engaging the lower surface of the backing of the underlying substrate.

12. The apparatus of claim 11, wherein the upper surface of the central base member includes a plurality of upwardly extending spikes that are adapted to engage the floor covering

13. The apparatus of claim 11, wherein the upper surface of the central base member includes an adhesive for bonding a lower surface of the floor covering to the upper surface of the central base member.

14. The apparatus of claim 11, wherein the adhesive is covered by a removable protective membrane, that is that is peeled off to expose the adhesive for attachment to the lower surface of the floor covering.

15. The apparatus of claim 14, further comprising:
a plurality of hooks extending upward from the upper surface of the central base member; and
an anchor tab having a lower surface thereof including a plurality of mating hooks for engaging the hooks extending from the upper surface of the central base member, and an upper surface thereof including an adhesive for attachment of the anchor tab to the lower surface of the floor covering.

16. The apparatus of claim 15, further comprising a removable protective membrane covering the adhesive on the anchor tab, that is peeled off to expose the adhesive for attachment of the anchor tab to the lower surface of the floor covering.

17. The apparatus of claim 9, wherein the backing of the underlying substrate defines a lower surface thereof, and the apparatus further comprises a single downwardly extending spike having a thread on an outer surface thereof for threadably engaging the lower surface of the backing of the underlying substrate.

18. The apparatus of claim 17, wherein the upper surface of the central base member includes a plurality of upwardly extending spikes that are adapted to engage the floor covering.

19. The apparatus of claim 17, wherein the upper surface of the central base member includes an adhesive for bonding a lower surface of the floor covering to the upper surface of the central base member.

20. The apparatus of claim 17, wherein the adhesive is covered by a removable protective membrane, that is peeled off to expose the adhesive for attachment of the anchor tab to the lower surface of the floor covering.

21. The apparatus of claim 17, further comprising:
a plurality of hooks extending upward from the upper surface of the central base member; and
an anchor tab having a lower surface thereof including a plurality of mating hooks for engaging the hooks extending from the upper surface of the central base member, and an upper surface thereof including an adhesive for attachment of the anchor tab to the lower surface of the floor covering.

22. The apparatus of claim 21, further comprising a removable protective membrane covering the adhesive on the anchor tab, that is that is peeled off to expose the adhesive for attachment to the lower surface of the floor covering.

23. The apparatus of claim 1, wherein the underlying substrate is a smooth surface, and the lower surface of the central base member includes an adhesive for attaching the apparatus to the underlying substrate.

24. The apparatus of claim 23, further comprising a removable protective membrane covering the adhesive on the lower surface of the central base member, that is that is peeled off to expose the adhesive for attachment of the apparatus to the underlying substrate.

25. The apparatus of claim 23, wherein the upper surface of the central base member includes a plurality of upwardly extending spikes that are adapted to engage the floor covering.

26. The apparatus of claim 23, wherein the upper surface of the central base member includes an adhesive for bonding a lower surface of the floor covering to the upper surface of the central base member.

27. The apparatus of claim 26, wherein the adhesive is covered by a removable protective membrane, that is peeled off to expose the adhesive for attachment of the anchor tab to the lower surface of the floor covering.

28. The apparatus of claim 23, further comprising:
a plurality of hooks extending upward from the upper surface of the central base member; and
an anchor tab having a lower surface thereof including a plurality of mating hooks for engaging the hooks extending from the upper surface of the central base member, and an upper surface thereof including an adhesive for attachment of the anchor tab to the lower surface of the floor covering.

29. The apparatus of claim 28, further comprising a removable protective membrane, covering the adhesive on the anchor tab, that is peeled off to expose the adhesive for attachment to the lower surface of the floor covering.

30. An apparatus for securing a rug to an underlying carpet having a pile layer extending upward from a backing defining a lower surface thereof, the apparatus comprising:
a button-like central base member adapted to be placed between the rug and the underlying carpet;
the central base member having an upper surface thereof adapted for engaging the rug, and a single downwardly extending spike is adapted for penetrating completely through the pile layer and backing of the carpet and engaging the lower surface of the backing, to thereby fixedly attach the apparatus to the underlying carpet.

31. The apparatus of claim 30, wherein the downwardly extending spike includes a barb at a distal end thereof for engaging the lower surface of the backing of the carpet.

32. The apparatus of claim 30, wherein the downwardly extending spike includes a thread on an outer surface thereof for threadably engaging the lower surface of the backing of the underlying substrate.

33. The apparatus of claim 32, further comprising, one or more gripping elements for grasping and applying torque to the apparatus, to thereby facilitate threadably screwing the apparatus into the backing of the carpet.

34. The apparatus of claim 33, wherein the button-like central base member includes one or more torque receiving elements for applying torque to the apparatus, to thereby facilitate threadably screwing the apparatus into the backing of the carpet.
